(19) United States
(12) Patent Application Publication
(10) Pub. No.: US 2017/0180680 A1
(43) Pub. Date: Jun. 22, 2017

(54) OBJECT FOLLOWING VIEW PRESENTATION METHOD AND SYSTEM

(71) Applicant: Hai Yu, Woodbury, MN (US)

(72) Inventor: Hai Yu, Woodbury, MN (US)

(21) Appl. No.: 14/976,258

(22) Filed: Dec. 21, 2015

(51) Int. Cl. H04N 7/18; H04N 5/232

(52) U.S. Cl. CPC H04N 7/183; H04N 5/23203; H04N 5/23238

(57) ABSTRACT

Method and system providing service of view presentation focusing on automatically tracked object to service users, where each service user has individually specified target object of interest. First, a high resolution panorama image is generated from at least one camera view image to capture the wide-angle view over an activity field. Second, for each connected service user, a customer view frame is determined inside the panorama image frame. The customer view frame specifies the image area where a target object is presented in focused view. The position and size of the customer view frame are determined according to the position and size of the tracked target object as well as the user's view navigation inputs. The image data inside the customer view frame are extracted from the panorama view image and are processed into customer view image to display on connected service user's displaying devices.

### TECHNICAL FIELD

The present invention is in the field of automatic camera view presentation controls, pertains more particularly to system and method for providing quality focused view presentation over moving objects in sports, performance and presentation activities. The invented automatic object tracking view presentation system and method aim at supporting performance recording and assessment for high quality self-training, remote-training, and video sharing purposes.

### BACKGROUND

In sports and performances, it is highly desirable to have a way to help people reviewing their performance with sufficiently focused motion details in order to improve their skills during training exercise and practice. Camera systems and mobile displaying device are more and more intensively involved in such training assistant system. The cameras produce video streams that can be displayed on user's smartphone and tablet computers. Both trainees and their coaches can review the recorded performance and exhibition to find out the gap and improvement potentials in the trainee's performance skills.

However, traditional performance recording processes usually need a professional cameraman to manually operate the orientation and zoom of the camera in order to have a performer presented in the camera view with sufficient focuses on motion details. Such assistant services are hardly available or affordable for common exerciser and nonprofessional players on a regular basis.

The auditorium cameras capture view image over the activity field. However, in conventional auditorium camera systems, each camera can only cover limited view region and users have to switch among many camera views to watch different regions of an activity field. Some other system combines all the camera images to generate one wide-angle view image. This enable the audience to watch the whole performance but it loss the ability to focus at single performer that moves around the activity field. Moreover, when the image data is transmitted to the displaying devices of crowd audience, either the number of audience has to be very limited or the image quality has to be sacrificed due to the data message throughput of the communication system. Moreover, a manually operated zoom-in view over a performer is unable to continuously follow the motion of the performer while still retaining sufficient focusing and centering on the performer in activity.

In order to provide the services of automatic object tracking view presentation, this invention discloses view presentation control method and system that can provide high quality object-focused view presentation to track user specified object automatically in view. Such a service system has not been available in common public sport or activity places. Existing auto-focusing camera systems are incapable to follow the dynamic motions of a performer while capturing sufficient details of the performance.

The invented automatic object tracking view presentation system integrates camera systems, displaying devices, communication networks, computerized control system, and object tracking and positioning system. It is able to provide automatic object viewing applications including: general object locating; target object specification from displaying devices; automatic object following and view focusing control; view presentation video playing and recording; etc.

First, a high resolution panorama view image is generated from camera systems to capture the wide-angle view over an activity field. Second, for each connected service user, a customer view frame is defined inside the panorama view image. The customer view frame specifies the area inside the panorama view image where the service user wants to have focused view presentation. The size and position of the customer view frame are determined based on view navigation data comprising user's view navigation inputs and, most importantly, the automatic object tracking data. By recognizing the position and size of a target object, the position and size of the customer view frame gets updated accordingly after a new panorama view image is generated such that the image of the target object is sufficiently covered and centered inside the panorama view image area that is enclosed by the customer view frame.

The image data inside the customer view frame are extracted from the panorama view image and are processed into customer view image. As such, the data transmission is minimized when sending only the customer view image to crowd users within communication throughput limit.

The invented automatic object tracking view presentation system provides services at public activity places. Users can access the service from their mobile device, like smartphones, and select desired target object to follow in presented view. Users can watch and review performance video transmitted or recorded on their mobile devices, or from any network connected computerized displaying devices, like desktop/laptop/tablet computers, smartphone, stadium large screen, etc.

The invented automatic object tracking view presentation system aims at supporting performance recording and assessment in activities like sports, performances and exhibitions. It provides a high quality auto-focus and auto-following view presentation solution to satisfy the needs of performance assessment and professional video sharing in training and sport activities.

### SUMMARY OF THE INVENTION

The following summary provides an overview of various aspects of exemplary implementations of the invention. This summary is not intended to provide an exhaustive description of all of the important aspects of the invention, or to define the scope of the inventions. Rather, this summary is intended to serve as an introduction to the following description of illustrative embodiments.

Illustrative embodiments of the present invention are directed to a method and a system with a computer readable medium encoded with instructions for providing automatic object tracking view presentation for crowd service applications.

In a preferred embodiment of this invention, at least one video stream is captured from at least one camera system. A high resolution panorama view image is generated from the camera view image received from the camera video stream. The panorama view image provides a wide angle view that covers an activity field. For each connected service user, a customer view frame is defined inside the panorama view image. The customer view frame specifies a closed geometric area inside the panorama view image where the service user wants to have focused view presented. The size and position of the customer view frame are determined based on user's view navigation inputs and, most importantly, on automatic object tracking data. By recognizing the position and size of a target object, the position and size of the customer view frame gets updated accordingly after a new panorama view image is generated or loaded such that the image of the target object is sufficiently covered and centered inside the panorama view image area that is enclosed by the customer view frame. The image data inside the customer view frame are extracted from the panorama view image and are processed into customer view image. The customer view image is transmitted to user's terminal displaying device for presentation and video recording.

The invention disclosed and claimed herein comprises generating a high resolution panorama image to provide overview image over an activity field 14. The panorama image can be produced from a single camera view image, where the whole camera view image or an area of the camera view image is used as the source for panorama image production. The invention disclosed and claimed further comprise a method for generating the panorama view image from a plural of camera view images that are captured from at least one camera system. The production of the panorama view image using multiple camera view images involves either an image stitching method or an image combination method that uses predefined image stitching scheme. Image transformation methods may also involve in the panorama view image production.

The invention disclosed and claimed herein comprises determining a customer view frame inside the panorama view image for each connected user. In a preferred embodiment of the present invention, the customer view frame is a rectangle region inside the panorama view image. In some other embodiments of the present invention, the customer view frame has a quadrilateral shape inside the panorama view image. The position and size of the customer view frame is first determined based on the identified position and size of a target object that has been specified by each connected user. The position and size of the customer view frame is secondly determined relatively based on user's view navigation inputs. Exemplary embodiments of the position and size relationship between the customer view frame and those of the target object include but not limited to centering, center aligning, offset, rotation, expanding, shrinking, aspect ratio adjustment, and shape variations.

In some embodiments of the present invention, the identified position and size of the target object are obtained as the evaluated position and size of a general object located in the panorama view image and such a general object is being specified as the target object of interest by a connected user.

In some embodiments of the present invention, the identified position and size of the target object are obtained as the evaluated position and size of a general object located in the panorama view image and such a general object is recognized as the target object for a connected user by the view presentation control system.

In some embodiments of the present invention, the customer view image is produced using image data extracted from the panorama view image data and such extracted image data corresponds to the portion of panorama view image that is inside the customer view frame. The invention disclosed and claimed may further comprise producing the customer view image by processing the extracted image data using methods include but not limited to: resize, resolution conversion, format conversion, color conversion, rotation, perspective transformation and 3D transformation. For each connected user, the customer view image is next transmitted to the user's displaying device via a communication network. The customer view image can be display and recorded on the user's displaying device.

In some other embodiments of the present invention, the identified position of the target object is obtained from the position measurement of a positioning device. The identified size of the target object is next obtained as the evaluated size of a general object recognized as the target object at a position corresponding to the position measurement in a panorama view image that is associated to the position measurement. In this case, the panorama view image that is associated to the position measurement is also used subsequently to extract the image data for generating the customer view image. Exemplary embodiments of the association methods for the position measurement and the panorama view image include but not limited to time series association and frame sequence association.

In yet other embodiments of the present invention, the identified position and size of the target object are obtained from the object location data of an object tracking device to determine the position and size of the customer view frame. Each set of the object location data is associated to a generated panorama view image. The image data inside the determined customer view frame from the associated panorama view image are extracted to produce the customer view image. Exemplary embodiments of the association methods for the object location data and the panorama view image include but not limited to time series association and frame sequence association.

Illustrative embodiments of the present invention are directed to method, system and apparatus for providing focused view navigation inside a panorama view for crowd service that enabling customized and focused view for each connected service user. Exemplary embodiments of the invention comprise at least one camera system; at least one displaying device; at least one communication network; and a computer based view presentation control service center. Additional features and advantages of the invention will be made apparent from the following detailed description of illustrative embodiments.

### BRIEF DESCRIPTION OF THE DRAWINGS

FIG. 1 is a schematic diagram of a view presentation control system that provides automatic object tracking and focused view presentation inside a panorama view image for crowd service according to one or more embodiments;

FIG. 2 is a flowchart illustrating an automatic object tracking view presentation control method for crowd service according to one or more embodiments;

FIG. 3 is a schematic diagram illustrating a method of generating 2D panorama view image from a plural of camera view images according to one or more embodiments;

FIG. 4 is a flowchart illustrating a method of generating panorama view image according to one or more embodiments;

FIG. 5 is a schematic diagram illustrating a method of determining the position and size of the customer view frame based on the identified position and size of the target object according to one or more embodiments;

FIG. 6 is a schematic diagram illustrating a method of determining the position and size of the customer view frame relatively based on the user's view navigation input according to one or more embodiments;

FIG. 7 is a schematic diagram illustrating a method for generating customer view navigation input from user's displaying device according to one or more embodiments;

FIG. 8 is a flowchart illustrating a method for client service control and for updating the relative position and sizing parameters of the customer view frame based on received user's view navigation input according to one or more embodiments;

FIG. 9 is a flowchart illustrating a method for determining the position, size and shape parameters of the customer view frame according to one or more embodiments;

FIG. 10 is a schematic diagram illustrating a system for determining the identified position and size of the target object according to one or more embodiments;

FIG. 11 is a flowchart illustrating a method for determining the identified position and size of the target object according to one or more embodiments;

FIG. 12 is a flowchart illustrating a method for generating customer view image according to one or more embodiments.

FIG. 13 is a flowchart illustrating a method for customer view image presentation on a user's displaying device according to one or more embodiments.

### DETAILED DESCRIPTION OF THE INVENTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The present invention discloses method and system for providing view presentation control inside a panorama view for crowd service such that each connected service user can have an individually specified target object automatically tracked and continuously presented in focused view on user's displaying devices. For each connected service user, the invented system controls a customer view frame inside a panorama view image. The shape, size and position of the customer view frame are determined based on user's view navigation inputs and, most importantly, on use's object specification and automatic object tracking data.

The customer view frame determines a sub-region inside a panorama view image where the user wants the view presentation to focus on. By identifying the position and size of a target object, the position and size of the customer view frame gets updated accordingly after a new panorama view image is generated such that the image of the target object is sufficiently covered and centered inside the panorama view image area that is enclosed by the customer view frame. The image data inside the customer view frame are extracted from the data structure of the panorama view image and they are used to produce the customer view image that will be transmitted to the user's displaying device for video presentation and recording applications.

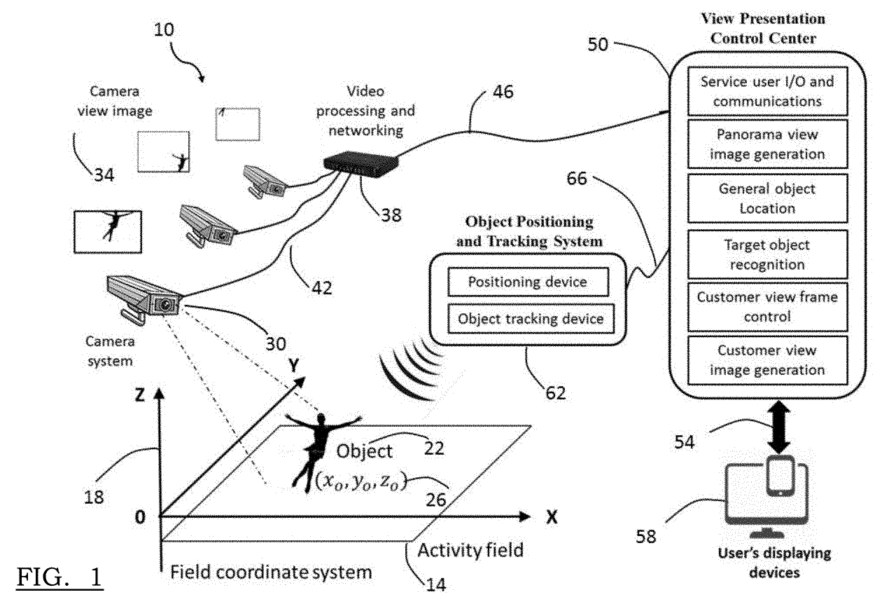

With reference to FIG. 1, a view presentation control system that provides automatic object tracking and focused view presentation inside a panorama view image for crowd service is illustrated in accordance with one or more embodiments and is generally referenced by numeral 10. The service system 10 comprises at least one camera system 30 for capturing camera view image and transmitting encoded camera view video stream, a video processing and networking unit 38, a computer based view presentation control center 50, and at least one user's displaying device 58. In some embodiment of the present invention, the service system 10 further comprises an object positioning and tracking system 62 that is able to provide measurement data on the position and size of objects that can be used to support automatic object tracking in view presentations.

The camera system 30 connects to the video processing and networking unit 38 through the communication channel 42. The video processing and networking unit 38 connects to the view presentation control center 50 through the communication channel 46. The user's displaying device 58 connects to the view presentation control center 50 through the communication channel 54. The object positioning and tracking system 62 connects to the view presentation control center 50 through the communication channel 66. All the communication channels together construct the communication network used in this view presentation control system 10.

The communication network connects all the devices in the service system for data and instruction communications. Primary embodiments of the communication network are realized by the WiFi network and Ethernet cable connections. Alternative embodiments comprise wired communication networks (Internet, Intranet, telephone network, controller area network, Local Interconnect Network, etc.) and wireless networks (mobile network, cellular network, Bluetooth, etc.). Extensions of the service system also comprise other internet based devices and services for storing and sharing recorded customer view videos as well as the recorded panorama view videos.

In the illustration, an activity field 14 is represented by a figure skating ice rink that is covered in the camera view of at least one camera system 30. A field coordinate system X-Y-Z 18 may be defined for this activity field 14 to support position measurement in the object positioning and tracking system 62 such that each position inside the activity field 14 has a unique position coordinate (x, y, z). An object 22 in the activity field 14 is illustrated as a skater that has an object position in the field coordinate system 18 as (xₒ, yₒ, zₒ) 26. An object that is spotted and presented in the camera view images is labelled as a general object 22. Any general object 22 can be specified by a connected service user as his/her target object that will be tracked automatically and presented continuously in the view presentation displayed to the service user thereafter.

The camera system 30 comprises a camera device for capturing camera view image and for transforming the camera view image in video stream to the view presentation control center 50 via video processing and networking unit 38. In some embodiment of the present invention, the camera system 30 may communicate directly with the view presentation control center 50. Each camera system 30 has at least one camera view image 34 captured and encoded into video stream.

Embodiment of the camera device used is either a static fixed orientation camera device or a Pan-Tilt (PT) camera device. At a certain lens orientation position and zooming ratio, the camera view image 34 can either provide a focused view over a small area in the activity field 14 or an overview over a large area in the activity field 14. Due to data size and view coverage limitation, each of the camera view image may only cover a certain sub-area of the activity field 14. When the activity field 14 is quite large, single camera view image 34 is not sufficient for achieving high resolution view coverage over the whole activity field 14. In this case, multiple cameras systems 30 are usually installed to achieve full field coverage by proper arrangement and coordination of all the camera view coverages. The panorama view image constructed from a plurality of camera view images is able to provide sufficient view coverage over the activity field 14 while still retaining adequately high image resolution to reveal detailed object information. Other types of static camera devices, like pinhole cameras, can have nearly full view coverage over an activity field 14. Since their view frames have strong distortion, their view image has to be de-wrapped using 3D transformation to generate a final panorama view image.

When a plural of camera view images are used to generate the panorama view image, image combination method is used to produce the panorama view image. Exemplary image combination methods include but not limited to image transformation method, image stitching method, and image combination method with predefined image stitching scheme and/or image transformation scheme. The generated panorama view image has a 2-dimensional panorama view image coordinate system W-H defined for it such that each pixel point on the panorama view image has a unique image position coordinate (wₚ, hₚ) to identity its location. By integrating the panorama view image generation and the view navigation method together, this invention achieves the application of crowd sharing capable and automatically controlled object tracking view presentation service uniquely.

A user's displaying device 58 is a computerized device that comprises memory, screen and at least one processor. Exemplary embodiments of the displaying device are smartphone, tablet computer, laptop/desktop computer, TV set, stadium large screen, etc. After receiving the image data of the generated customer view image, the displaying device 58 can either display the customer view image video on its screen or record the customer view image into video records. Some exemplary embodiments of the displaying device have input interface, touch screen or mouse, to take user's view navigation commands and to communicate customer view navigation data with the view presentation control center 50. Some other embodiments of the displaying device comprises distributed system that comprises a set of devices that work on user interface, displaying, data and operation processing individually, or even through a computer network.

In some embodiments the system 10, the object positioning and tracking system 62 comprises only a positioning device that obtains the object position measurement in the activity field 14. Exemplary embodiments of such positioning device include local positioning devices that use either WiFi signal, radio frequency signal, infrared or laser signals to detect object's position. Other exemplary embodiment of such positioning device include global positioning device, like GPS. In some other embodiments of the system 10, the object positioning and tracking system 62 further comprises an object tracking device that reports object location data containing both object position measurement and object size estimation. Exemplary embodiments of such object tracking device include Inertial Measurement Unit, object size sensing and estimation unit, infrared object detection device, laser scanning and surrounding profiling device, etc. The obtained object position coordinate (xₒ, yₒ, zₒ) in the field coordinate system 18 can be transformed to a unique pixel position (wₚ, hₚ) in the panorama view image coordinate system. The obtained object sizing information can also be transform from its data in the filed coordinate system 18 to the panorama view image coordinate system, for example, in a data structure defined for a rectangle shape. The final object positioning and sizing information is reported to the view presentation control center 50 through communication channel 66.

The view presentation control center 50 is a computer device that comprises memory and at least one processor. The view presentation control center 50 is designed to provide a bunch of system operation functions comprising: service user input/output control and communications; panorama view image generation; general object location and motion; target object recognition; customer view frame control and customer view image generation. By allowing each connected user's displaying device 58 to navigate inside the panorama view and to specify target object to be tracked in view, each of the service user can have, on his/her displaying device, the automatic and focused view presentation following the motion of the individually specified target object in the activity field 14.

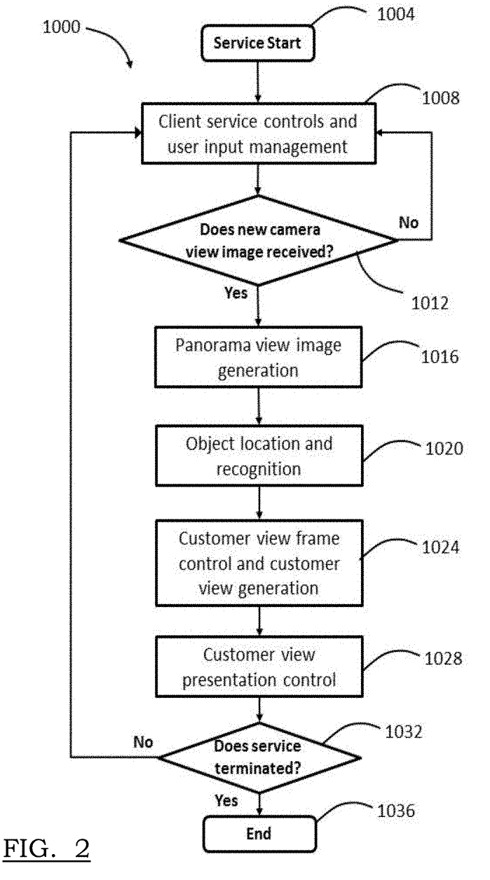

With reference to FIG. 2, an exemplary view presentation control method of the automatic object tracking view presentation system is illustrated according to one or more embodiments and is generally referenced by numeral 1000. This method realizes all the control functions of the view presentation control center 50.

After service starts at step 1004, this method first carries out client service control and user input management at step 1008. The client service control establishes service connection with new user once service request is received and it manages user account information, user profile data, and all other user oriented service system parameters. For each connected user, a customer view frame is defined to specify where inside a panorama view image the user want to have focused view presentation. For connected users, the user input management executes the control and operation commands received to finish control tasks like target object specification and cancellation, customer view frame relative adjustments on shape, position and size, etc. A connected user will be removed from service once disconnection request is received from his/her displaying device.

Next, the method 1000 checks on if there is a newly updated camera view image received at step 1012. If not, the method 1000 will continue waiting for camera view image update while watching on client service control and user input management at step 1008. Once a camera view image update condition is satisfied at step 1012, the method 1000 next starts on generating a new high resolution panorama view image from the available one or a plural of camera view images at step 1016. Some embodiment of the method 1000 starts new panorama image generation after the updates on all of the camera view images involved or on a certain amount of camera view images are finished. The panorama view image is basically a data structures containing image data in a certain data format. In some embodiments of the present invention, the panorama view image is generated offline before the start of the view presentation service. In this case, the automatic object tracking view presentation service is carried out by loading sequentially the preprocessed panorama view image for object recognition and customer view image generation.

In the generated panorama view image, general objects are spotted and their position and size are evaluated inside the panorama view image at step 1020. In this step, image processing and object recognition methods are typically used to scan the panorama view image and to identify all candidate objects that are presented in the view covered activity field 14. In a preferred embodiment of the method 1000, the position and size of the spotted general objects are represented by a rectangle envelop that encloses the image of the general object tightly in the panorama view image. The general object envelop has its center position (w_{g}, h_{g}) and its width W_{g} and height H_{g} and the parameter set for the general object envelop is represented as (w_{g}, h_{g}, W_{g}, H_{g}) and all the parameters are defined in the panorama image coordinate system.

After finishing general object location, for each connected user that has a target object specified, advanced object recognition methods are used to further recognize among all general objects the target object to be tracked in view. Exemplary methods for advanced object recognition include but not limited to: feature matching method, optical flow method, template matching method, motion validation method, neural network method and key point matching method, etc. Once a general object is recognized as the target object, its position and size inside the panorama view are rendered as the identified position and size for the target object. Digital signal filter may be used in the rendering process. In a preferred embodiment of the method 1000, the position and size of the target object is also identified by a rectangle envelop with parameters (wₒ, hₒ, Wₜ, Hₜ) and the target object envelop inherit the values of the general object envelop from a general object that has been recognized as the target object, such that (wₒ, hₒ, Wₜ, Hₜ)=(w_{g}, h_{g}, W_{g}, H_{g})ᵢ, where the subscript i denote the envelop parameter set for the i-th general object. In the following description, the target object envelop is frequently used to represent the identified position and size of the target object inside the panorama view image.

In some embodiments of the step 1020, the general object scanning and spotting process may only be carried out in a sub-region inside the panorama view image. And the sub-region used is sufficiently large and it surrounds a previously known position of the target object.

In some embodiments of the method 1000, the object position is measured separately by a positioning device in the object positioning and tracking system 62. In this case, the identified position of a target object is obtained by transforming the position measurement from the field coordinate system 18 to the panorama view image coordinate system. The identified size of the target object is obtained as the size of a general object recognized as the target object at a position corresponding to the position measurement in a panorama view image that is associated to the position measurement. In this case, the panorama view image that is associated to the position measurement is also used subsequently to extract the image data for generating the customer view image. The association between the object position measurement and the panorama view image is established either through time synchronization or through frame sequence synchronization.

In some other embodiments of the method 1000, the identified position and size of the target object are both obtained from an object tracking device in the object positioning and tracking system 62. The object location data contains the measured/estimated object position and size. Such measured/estimation position and size of the target object in the field coordinate system 18 can be used to derive the identified position and size of the target object, and subsequently, to determine the position and size of the customer view frame. Each set of the object location data is associated to a generated panorama view image. The image data inside the determined customer view frame from the associated panorama view image are next extracted to produce the customer view image. The association between the object location data and the panorama view image is established either through time synchronization or through frame sequence synchronization.

For a connected user that has not have his/her target object specified, the customer view frame is determined purely by user's view navigation input such that a customer view image is generated from the panorama image data inside the customer view frame accordingly as an overview image into the activity field 14. In this case, all the spotted general objects that are covered in view by an overview image will be highlighted, e.g. by displaying the object envelops, while the overview image is displayed on the user's displaying device. Any of the general objects that are highlighted in the overview image can be selected as the target object for each of the connected users. In an exemplary embodiment, a service user specifies a general object as his/her target object of interest by tapping inside the rectangle envelop surrounding the general object on the screen of the user's displaying device. A target object is specified with its initial identified position and size rendered as the evaluated position and size of the general object selected.

For each connected service user, the defined customer view frame is managed at step 1024. The customer view frame is a closed geometric region inside the image area of the panorama view image. A rectangle shaped region is typically used to define the customer view frame with position and size parameter defined as (w_{f}, h_{f}, Wᵥ, Hᵥ). Some other embodiments of the customer view frame include quadrilateral shapes, like trapezoid that is used to enable perspective transformation effects.

The position and size of the customer view frame are determined based on view navigation data comprising user's view navigation inputs and, most importantly, the automatically tracked target object's position and size. The determination is first based on the identified position and size of the target object that has been specified by each connected user. The position and size of the customer view frame is secondly determined relatively based on user's view navigation inputs. Exemplary embodiments of the position and size relationship between the customer view frame and those of the target object include but not limited to centering, center aligning, offset, rotation, expanding, shrinking, aspect ratio adjustment, and shape variations. By identifying the position and size of a target object, the position and size of the customer view frame gets updated accordingly after a new panorama view image is generated or loaded such that the image of the target object is sufficiently covered and centered inside the panorama view image area that is enclosed by the customer view frame. A connected service user may build up multiple connected view presentation services within one application and thus the user can have more than one target object tracked and presented in delivered view presentations. In some embodiment of the method 1000, the target object is a group object that comprises multiple general objects. In this case, the target object envelop is determined by a minimal rectangle region that enclose all the general object envelops inside the panorama view image.

For each customer view frame, after initialized with default relative position and sizing parameters, its appearance can be adjusted by user's view navigation inputs received from the user's displaying device 58. In an exemplary embodiment, user's view navigation input on a touch screen may comprise move-up, move-down, move-left, move-right, open, close, and rotation to a certain angle and in a certain direction (clockwise or counter-clockwise) with respect to a rotation center. Such view navigation inputs from the displaying device 58 are communicated to the view presentation control center 50 and they are executed to adjust the relative position and sizing parameters of the customer view frame with respect to the identified position and size of the target object. The corresponding adjustments comprise offset adjustment, stretching ratio adjustment, rotation angle adjustment, and deflection ratio adjustment, with respect to the target object envelop.

The image data inside the customer view frame are extracted from the panorama view image and are processed to generate the customer view image. A raw customer view image is first produced. Based on user's displaying settings and system configurations, the raw customer image can be further processed to finalize the customer view image through resize, 2D and/or 3D transformation, image decoration, image processing, etc.

For each connected service user, the customer view presentation control is executed at step 1028. The final generated customer view image or the overview image is transmitted and presented on the user's displaying device. Data compression method and socket communication method are typically used to send the image data to the user's displaying device. In addition, the generated customer view image can be recorded into view presentation video files.

The service method 1000 continues from step 1032 to step 1008 to repeat the service processing steps if the connected view navigation service is not terminated. Otherwise, it stops at step 1036. The service method illustrated in FIG. 2 only serves to present a minimal level of processing steps that the invented automatic object tracking view presentation service system comprises. In applications, service functions inside a realization of the invented view presentation service system 10 may take different sequences and the executions of certain functions can be independent or in parallel to the rest of function executions.

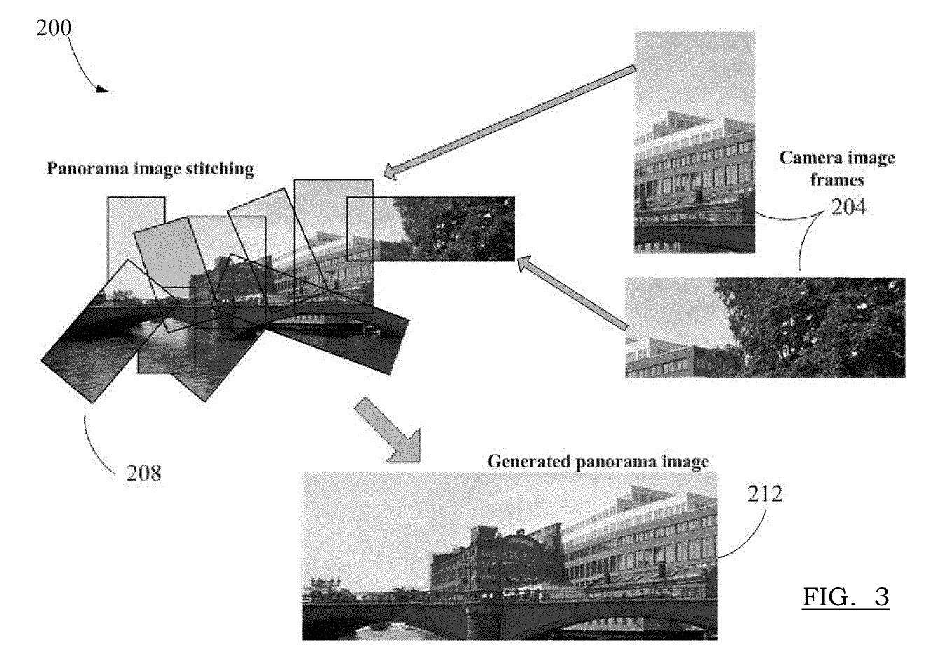

With reference to FIG. 3, a schematic diagram for a method of generating 2D panorama view image from a plural of camera view images is illustrated according to one or more embodiments and is generally referenced by numeral 200. This method starts with a plural of camera image frames 204 that are individually taken with overlaps in views over a scene or an activity field 14. Image stitching process 208 is used to combine the set of camera image frames to produce a high-resolution panorama view image 212 through computer based image processing. The image stitching process can be divided into three main steps: image alignment, calibration, blending and composing.

For image alignment, a mathematical model is determined to relate pixel coordinates in one image to pixel coordinates in another. In some embodiments of the method, image registration that combines direct pixel-to-pixel comparisons are used to estimate parameters for the correct alignments relating various pairs of images. Image registration involves matching features in a set of images to search for image alignments that minimize the sum of absolute differences between overlapping pixels. Distinctive features can be found in each image and then efficiently matched to rapidly establish correspondences between pairs of images. For panoramic stitching the ideal set of images will have a reasonable amount of overlap (at least 15-30%) to overcome lens distortion and to have enough detectable features.

Image calibration aims to minimize differences of optical defects such as distortions, exposure differences between images, camera response and chromatic aberrations between an ideal lens models and the camera-lens combination that is used. Image blending involves executing the adjustments figured out in the calibration stage, combined with remapping of the images to an output projection. Colors are adjusted between images to compensate for exposure differences. After that, a final compositing surface 212 is prepared to warp or projectively transform and place all of the aligned images on it. In the composing phase, the types of transformations an image may go through are pure translation, pure rotation, similarity transform that includes translation, rotation and scaling of the image which needs to be transformed, Affine or projective transform. As a result, all the rectified images are aligned in such a way that they appear as a single shot of a scene. The composing steps can be automatically executed in online video stitching applications by applying a pre-defined or program controlled image alignment scheme with known blending parameters.

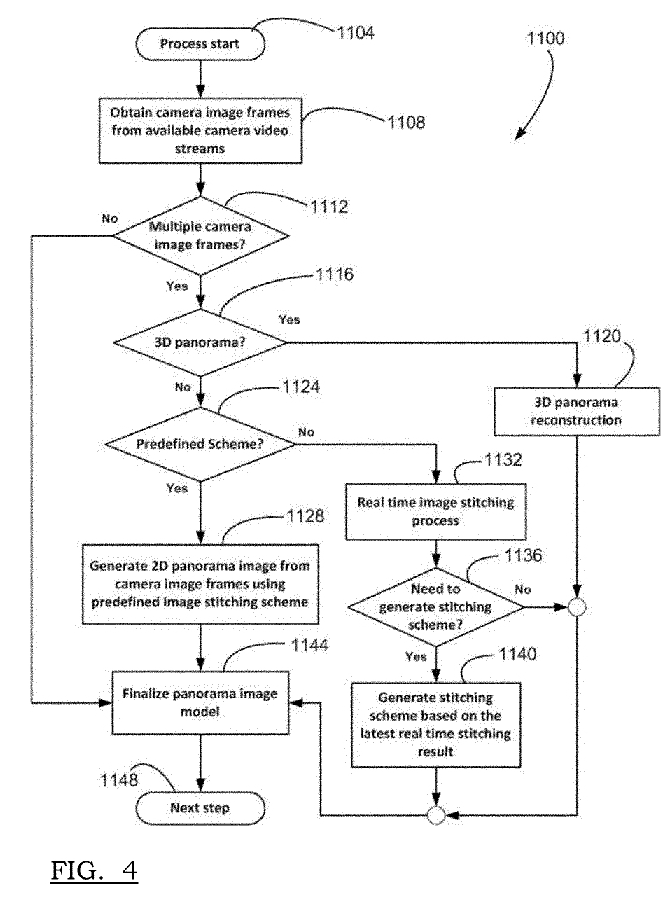

With reference to FIG. 4, a method of generating panorama view image model is illustrated according to one or more embodiments and is generally referenced by numeral 1100. After the process starts at step 1104, it first obtains camera view images from available camera view streams at step 1108. When the panorama view image generation is carried out offline, camera view images are loaded from different camera video records in a time synchronized manner to assure that all the camera view images used are taken at sufficiently close time instances that can be regarded as being taken at the same time.

If checked that only one camera view frame is available at step 1112, the single camera view frame will be finalized to generate the data structure model for the panorama image at step 1144. Different types of image processing techniques may be used to produce the panorama image based on a portion or the full image data from the single available camera view frame. On the other hand, if multiple camera image frames are available, the method 1100 will start generating the final panorama image out of a subset or all of the available camera view frames. To this end, the method 1100 first checks if 3-dimension (3D) panorama model is to be produced at step 1116. 3D reconstruction methods are used to produce the 3D panorama view if needed. Then, additional image modification, decoration, description and overlapping images can be made to finalize the 3D panorama image data structure model at step 1144.

If only 2-dimension (2D) panorama model is required, the method 1100 next check on if a predefined image combination scheme shall be applied at step 1124. A predefined image combination scheme contains known image stitching alignment and composing parameters to simplify and facilitate the live panorama image producing process at step 1128, especially when the cameras used in the view navigation system are fixed with known orientation, zoom, illumination and optical lens parameters. In the circumstances where the available camera view frames are taken rather dynamically, real time image stitching process has to be applied in step 1132 to produce the panorama image through the alignment and composing steps with necessary calibration and blending. This will put a high requirement on the system computing and processing capabilities as well as the amount of memory needed to support the processing operations. GPU computing units are commonly used when such application is needed. After that, the live produced panorama image template will go through the same finalization process at step 1144 to generate the final panorama view image's date structure model.

In some embodiments of the view navigation system, the cameras used may only adjust its view capture parameters from time to time and all the parameter values stay fixed after the adjustments. In this case, the image stitching parameters, after the adjustment is finished, can be saved to generate image combination scheme, which can be used without change afterwards. If this is needed and validated at step 1136, a new image combination scheme is generated at step 1140 to support future panorama image production at step 1124 and step 11128. After finalizing the generated panorama image data structure model at step 1144, the method 1100 will continue to execute other service control processes at 1148 to complete the view navigation service function.

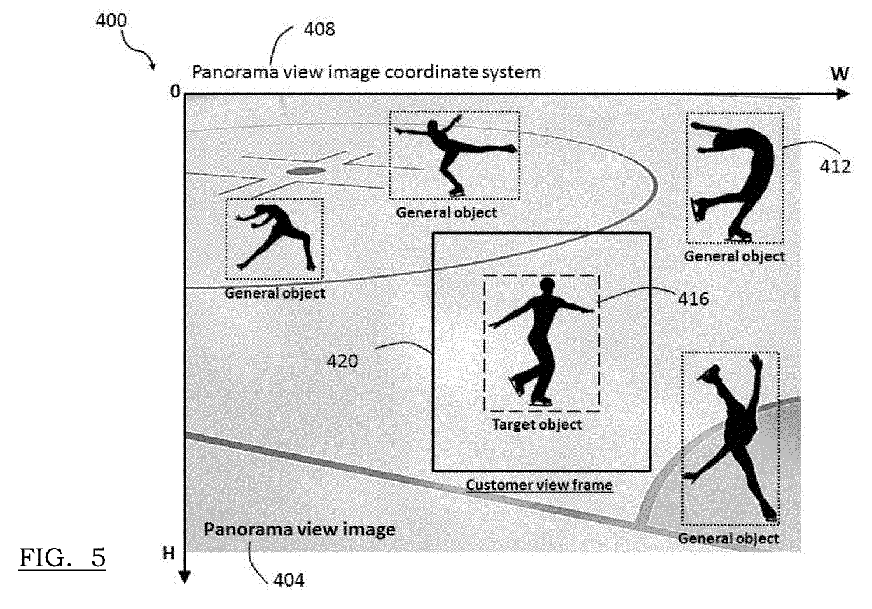

With reference to FIG. 5, a schematic diagram of the method for determining the position and size of the customer view frame based on the identified position and size of the target object is illustrated according to one or more embodiments and is generally referenced by numeral 400. An image that has its view over an area of an ice rink is used as an exemplary embodiment of the panorama view image 404. A panorama view image coordinate system W-H 408 is defined for the 2-dimensional panorama image such that each pixel point on this panorama image has a unique coordinate position (wₚ, hₚ). After generating the panorama view image 404, the view presentation control method 1000 first scans the image to spot and locate the general objects. In this schematic diagram, the general objects are illustrated as skaters on the ice rink. Each of the general objects, after being spotted and located with evaluated position and size, are enclosed by its general object envelop. The general object envelops are illustrated by dotted line rectangles 412. Given a i-th general object's envelop parameter (w_{g}, h_{g}, W_{g}, H_{g})ᵢ, the center position of the i-th general object is evaluated as (w_{g}, h_{g}). The size of the general object is evaluated as (W_{g}, H_{g}), where W_{g} is the object width and H_{g} is the object height in the panorama view image coordinate system, respectively.

The view presentation control method 1000 next scan through the general objects spotted to recognize the target object for each of the connected users. The target object 416, once recognized, inherit the object envelop from its original general object to identify its position and size. Based on the identified position and size of the target object, the customer view frame 420 is then determined as another rectangle shaped region with its center position determined relatively offset to the center position of the target object envelop and its width and height determined relatively with respect to the width and height of the target object envelop at certain stretching ratios. Similarly to the definition of the identified position and size for the target object, in a preferred embodiment of the presentation control method 1000, the position of the customer view frame is defined as the center position of the rectangle shaped region and the size of the customer view frame is defined by the width and height of the rectangle shaped region. In some embodiment of the control method 1000, the position of the target object is defined at a characteristic point on the image of the recognized target object instead of the center point of the target object envelop. The determined position of the customer view frame can align to the characteristic point position rather than the center point of the target object envelop in a center-aligning relationship method.

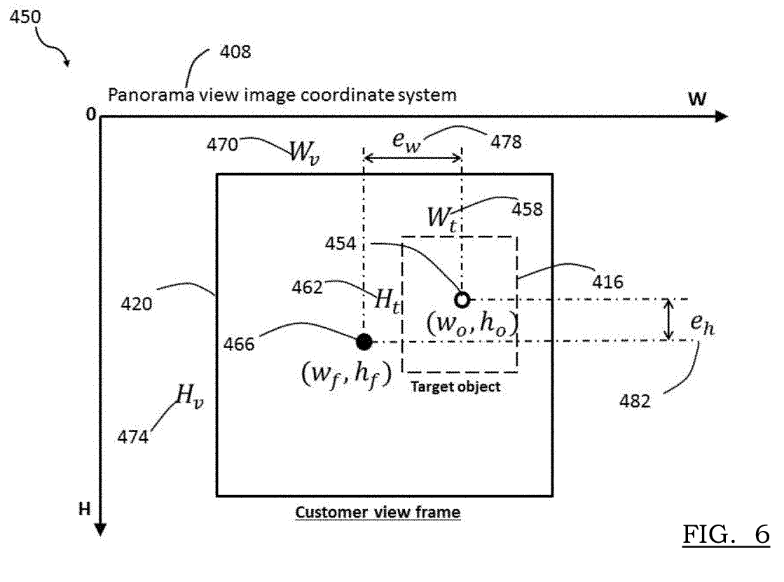

With reference to FIG. 6, a schematic diagram of the method for determining the position and size of the customer view frame relatively based on the user's view navigation inputs is illustrated according to one or more embodiments. In an exemplary embodiment, the identified position of the target object 416 is represented by the geometric center of its rectangle envelop 454 that has a coordinate (wₒ, hₒ) 454 in the panorama view image coordinate system 408. In some other embodiment, the identified position of the target object 416 is determined by a characteristic body point of the recognized target object. The target object envelop has a width of Wₜ 458 and a height of Hₜ462. In a preferred embodiment of the method 450, the customer view frame is defined as a rectangle in the panorama view image coordinate system 408 with a geometric center position at (w_{f}, h_{f}) 466, a width Wᵥ 470 and a height Hᵥ 474. The center position offset (e_{w}, eₕ) defines the relative position difference between the center of the target object and the center of the customer view frame, where e_{w} 478 defines the horizontal position difference and eₕ 482 defines the vertical position difference. When the offset parameters are zeros, the customer view frame is centered at the target object's position. When a characteristic point on the image of the target object is used as the identified position of the target object, centering aligning relationship is used to set the center point of the customer view frame at the characteristic point.

The stretching ratio (s_{w}, sₕ) defines the relative sizing of the customer view frame to the target object envelop, where s_{w}=Wᵥ/Wₜ and sₕ=Hᵥ/Hₜ. When s_{w} and sₕ are larger than 1, the customer view frame enclose the target object's envelop. The larger the stretching ratio parameters, the larger the size of the customer view frame is relatively to the size of the target object. On the other hand, when certain details on the target object is to be discovered, the stretching ratio parameters take values less than 1 in order to have the customer view frame zoom-in a certain sub-area inside the image of the target object. The customer view frame has a relative rotation angle φ to represent how much it is relatively rotated with respect to the right direction of the target object envelop. The customer view frame also has deflection ratio parameter defined to tell how it deflects from a rectangle shape when a quadrilateral shape is used. This is a useful feature when perspective transformation is needed in the final customer view image construction.

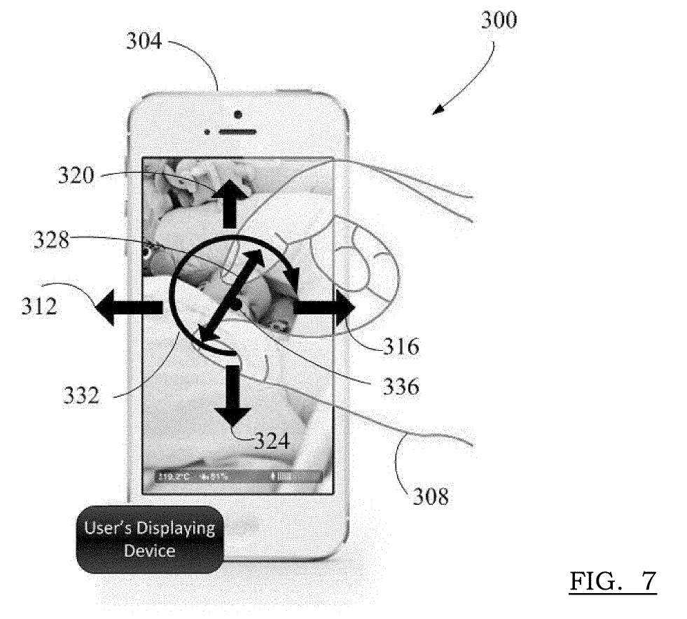

With reference to FIG. 7, a schematic diagram for a method of generating customer view navigation data from user's input to a displaying device is illustrated according to one or more embodiments and is generally referenced by numeral 300. In this exemplary illustration, the user's displaying device is represented by a cellphone 304 with an exemplary customer view image capturing a sleeping baby. And the user's input device is represented by hand fingers 308. In some other embodiments, the user's input device can be a computer mouse, a remote controller, a keyboard, and even a (vision, laser, radar, sonar, or infrared) sensor based gesture inputs.

On the touch screen of the cellphone, a figure slide left motion 312 is interpreted as pan left motion command to the customer view frame. Similarly, a figure slide right 316 commands pan right motion, a finger slide up 320 commands tilt up motion and a finger slide down 324 commands tilt down motion. A finger slide in an arbitrary angle can always be decomposed into the four basic finger slide based translational view navigation motions described before. For connected users that have no target object specified, such translational view navigation motions are directly interpreted as the corresponding pan and tilt motions of the customer view frame inside the panorama view image, where an overview image is generated out of the customer view frame subsequently. For connected users that have their target object specified, such translational view navigation motions control the relative offset of the customer view frame to the identified center of the target object. The values of the offset parameters (e_{w}, eₕ) get updated additively after new translational motion command is received from the user's displaying device.

When detecting two finger touch on screen, the pixel point of the customer view image corresponds to the geometric center point between the touch point of the two finger on the screen is regarded as the motion center 336. The two finger stretch out motion 328 is then interpreted as zoom-in motion with respect to the motion center 336, while two finger close motion is interpreted as zoom-out motion of the customer view frame 254 inside the panorama image frame 258. The two figure touch rotation motion 332 is then directly interpreted as the customer view frame's rotation motion at a corresponding rotation angle in the same rotation direction with respect to the motion center 336. For connected users that have no target object specified, such zoom and rotation motions are carried out absolutely inside the panorama view image to adjust the size and view angle of the overview image generated. For connected users that have their target object specified, such zoom and rotation motion are carried out relatively with respect to the target object envelop to adjust the stretching ratio and relative rotation angle of the customer view frame to change the size and the posture angle of the target object presented in the generated customer view image. In such a similar manner, more complicated view navigation inputs can be generated to produce complex customer view navigation motions in order to view different areas inside the panorama view image 404 or to achieve different object tracking view patterns.

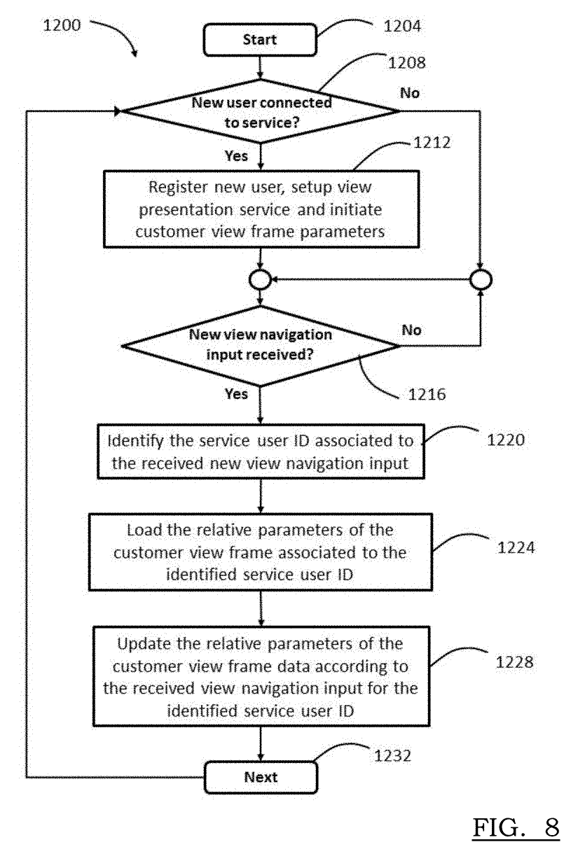

With reference to FIG. 8, a method for client service control and for updating the relative position and sizing parameters of the customer view frame based on received user's view navigation input is illustrated according to one or more embodiments and is generally referenced by numeral 1200. After the process starts at step 1204, new user connection request is checked at step 1208. When new user connection request is received, the method 1200 will setup view service for the new user and initiate customer view frame in the panorama view image and other necessary system service parameters and configurations at step 1212. The method 1200 next checks for each connected service user if new view navigation command is received from connected user's displaying device. The view navigation command contains controls to adjust the relative position and size of the customer view frame to the panorama view frame or to the target object envelop. Once received, step 1220 is carried out to first identify the service user ID that associates to the received new view navigation input. The relative position and sizing parameters of the customer view frame that belong to the identified service user are then loaded at step 1224. The offset parameters and the stretching parameters are updated respectively according to the type of view navigation command received. For example, a figure slide left motion 312 will add more negative offset to e_{w}; a finger slide up 320 will add more positive offset to eₕ; a two finger stretch-out action 328 will result in increasing the value of stretching parameters s_{w} and sₕ; a two-figure touch rotation motion 332 will result in changing the relative rotation angle φ accordingly. After that, the method 1200 will continue to step 1232 and then wait for future service connection request and view navigation input from step 1208.

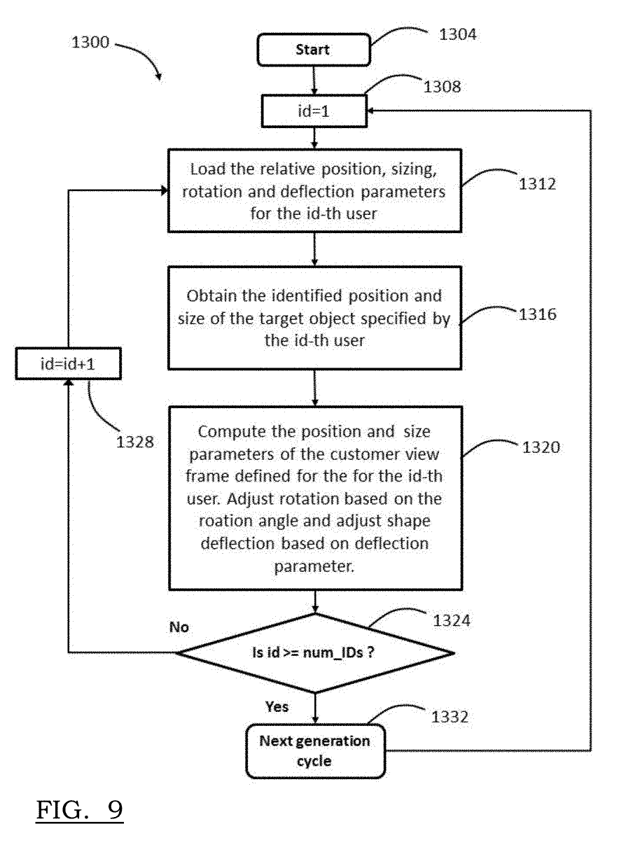

With reference to FIG. 9, a method for determining the position, size and shape parameters of the customer view frame is illustrated according to one or more embodiments and is generally referenced by numeral 1300. The method 1300 starts at 1304 after a new panorama view image is generated or loaded, and the identified position and size of the target object have been obtained. The process starts with the first connected user with id=1 at step 1308. The relative position and sizing parameters is first loaded at step 1312 for the id-th connected user at step 1312. The method 1300 next obtains the identified position and size of the target object associated to the id-th connected user at step 1316. The final position and size of the customer view frame are computed at step 1320 as: w_{f}=wₒ+e_{w}; h_{f}=hₒ+eₕ; Wᵥ=Wₜ·s_{w}; Hᵥ=Hₜ·sₕ. When shape deflection and rotation are involved in the determination of the customer view frame, the position and sizing parameters are next further adjusted based on the rotation angle and deflection ratio to finalize the position and size of the customer view frame. The method 1300 repeats the same processing in step 1312, step 1316 and step 1320 for the next connected user with id=id+1 at step 1328 until it is checked that the customer view frame updating has been done for all total num_IDs number of connected users that have target object specified at step 1324. After that, the process goes to step 1332 and wait for the next generation cycle until the next panorama view image is generated/loaded and the target objects have been located. Then a new cycle of computation for customer view frame updating starts from step 1308.

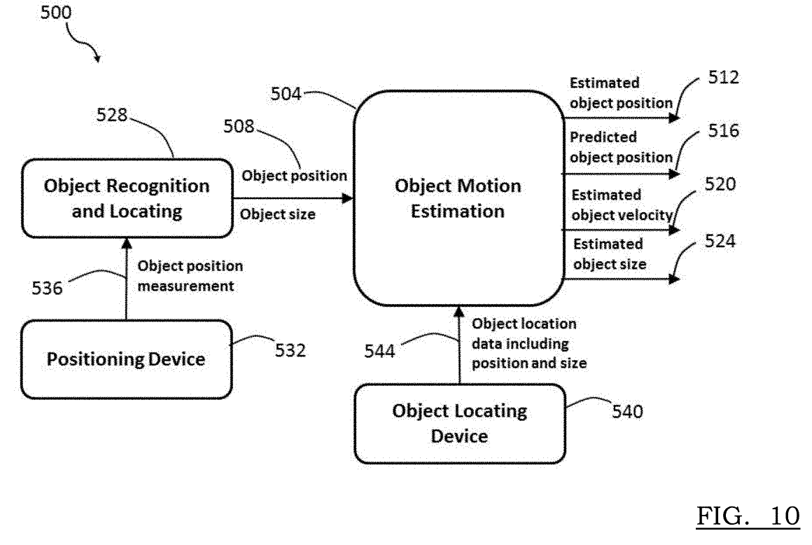

With reference to FIG. 10, a schematic diagram for the system of determining the identified position and size of the target object is illustrated according to one or more embodiments and is generally referenced by numeral 500. A primary embodiment of the system 500 comprises computer executable programs including an Object Recognition and Locating (ORL) function 528 and an Object Motion Estimation (OME) function 504. After a new panorama view image is generated, the ORL function 528 first scans through the panorama image and locates all candidate general objects with a rectangle envelop enclosing each of the candidate general objects tightly to define its position and size. Feature based support vector machine methods and neural network models are typically used in this step for general object spotting and locating. The object features used in this step are general object features like histogram of oriented gradient, object image template, characteristic points, etc. Next, for each of the general objects located, the ORL function 528 extracts and processes all the specific features that will be used in target object recognition step. Such specific features include but not limited to color histogram, local binary pattern, optical flow, object image contour template, and object image texture, etc. Machine learning methods and neural network are typically used in this feature learning process.

For each connected user, based on known target object's feature information, the target object is recognized by evaluating normalized similarity metrics between the candidate general objects and the target object. Typical similarity metric comprises but not limited to the evaluations on the position displacement, the template matching score, the characteristic point matching score, and the characteristic feature histogram difference, etc. The candidate general object that achieves the highest score on overall weighted similarity measures is set as the target object. After the recognition, all the newly process target object features are learned by the ORL function 528 to adopt new appearance and characteristic variations to better support future target object recognition.

Next, the evaluated position and size of the recognized general object 508 are sent to OME function 504 to synthesize for target object′ motion data. Digital signal filtering algorithms are implemented in the OME function 504. Embodiments of the digital signal filtering algorithms include but not limited to Kalman filter, particle filter, moving average filter, and Bayesian filter algorithms. After the information fusion processed in OME function 504, information about the position and motion of the target object is derived and such information include the estimated object position 512, the predicted object position in the next execution time cycle 516, the estimated object velocity 520, and the estimation object size 524. The estimated object position 512 and the estimated object size 524 are used as the identified position and size of the target object in subsequent customer view frame determination.

In some embodiment of the system 500, a positioning device 532 is used to provide position measurement 536 for the target object. The positioning device 532 resides in the object positioning and tracking system 62. Such position measurement 536 tells the position of the target object at a time instant in the field coordinate system 18. After transforming the position measured 536 to a corresponding position in the panorama view image coordinate system 408, the position measurement 536 assists the ORL function 528 in target object recognition by limiting the candidates to only the general objects near the measured target object's position within a certain distance threshold. In this way, the object recognition can be largely facilitated with better recognition accuracy.

The identified size of the target object is next obtained as the size of a general object recognized to be the target object in a panorama view image that is associated to the position measurement. The panorama view image that is associated to the position measurement is the panorama view image that is generated from camera view images that are captured at time instants sufficiently close to the time instant the position measurement is taken such that the panorama view image and the position measurement are regarded as containing the information about the activity field 14 at the same time. Such association methods are called time series association. In exemplary online applications, the position measurement is associated to the most recent panorama view image generated. When the position measurement time step and the panorama view image generation cycle time are known, the frame sequence association method can be used by matching the sequence number of the position measurement to the frame sequence label of the panorama view image. The panorama view image that is associated to the position measurement is also used subsequently to extract the image data for generating the customer view image.

In some other embodiment of the system 500, an object locating device 540 is used to provide object location data 544. The object locating device 540 resides in the object positioning and tracking system 62. The object location data contain measured or estimated position and size about the target object in the activity field coordinate system 18. The object location data are transformed to the panorama view image coordinate system 408 using coordinate transformation. The transformed position and size of the target object in the panorama view image coordinate system 408 are rendered as the identified position and size of the target object to support subsequent customer view frame determination. Digital signal filtering may be used in the rendering process. It is important to point out that, in this embodiment, each set of object location data is associated to a panorama view image generated. The associated panorama view image is then used in the view image data extraction and customer view image generation based on the customer view frame determined from the object location data. The time series association method or the frame sequence association method can also be used in this embodiment of system 500 to synchronize the object location data to the panorama view image generation.

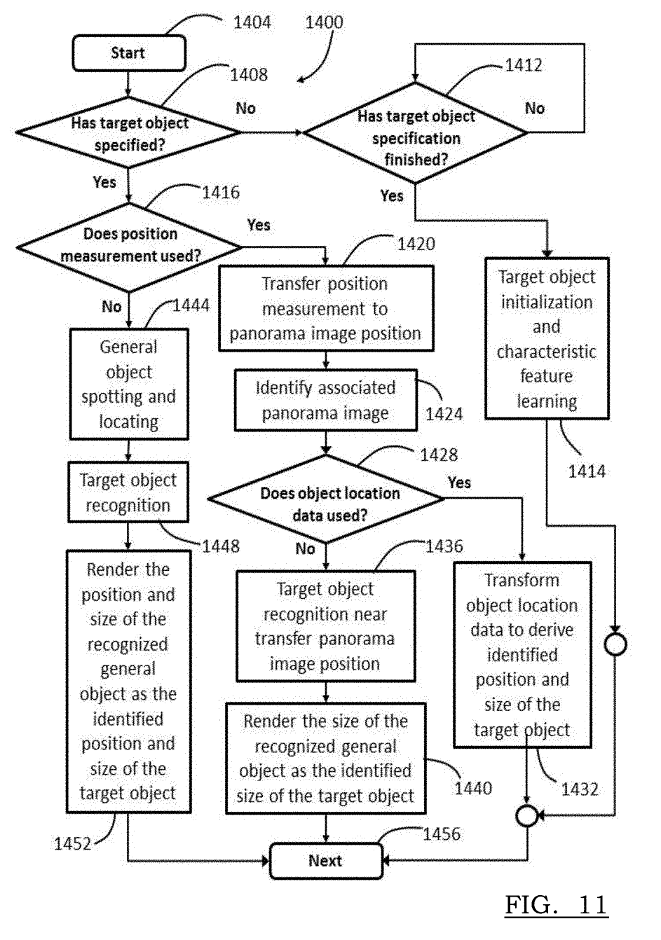

With reference to FIG. 11, a method for determining the identified position and size of the target object is illustrated according to one or more embodiments and is generally referenced by numeral 1400. After starting at step 1404, the method 1400 first checks on if a target object has been specified by the connected user at step 1408. If the target object has not been specified, the method will wait for user's input on target object specification command at step 1412. Once a target object specification command is received, the method goes to step 1414 to initialize the target object by rendering the specified general object's envelop position and size as the initial identified position and size for the target object. Furthermore, characteristic features are extracted from the image of the specified general object and learned by the ORL function 528 to support target object recognition in future panorama view image generation cycles.

If checked that the target object has been specified at step 1408, the method 1400 further checks on if position measurement from either a positioning device 532 or an object locating device 540 is used in target object position and size identification system 500 at step 1416. If used, the position measurement is transformed to the panorama view image coordinate system 408 to obtain the identified position of the target object at step 1420. The associated panorama view image is also identified at step 1424. The method 1400 next checks if an object locating device 540 is available and the object location data is used at step 1428. When used, step 1432 is carried out to transform the object location data to the panorama view image coordinate system 408 to derive the corresponding identified position and size of the target object. If the object locating device 540 is not used, then step 1436 is carried out after step 1428 to recognize the target object among all candidate general objects near the panorama view image position corresponding to the position measurement. The position and size of the recognized general object is then rendered as the identified position and size for the target object at step 1440. Digital signal filtering may be used in this rendering process. The object envelop is typically used directly to represent the object position and size in this step. At step 1416, if checked that there is no position measurement used, the method 1400 next scans through the panorama view image or a sub-region of the panorama view image surrounding the previous identified target object position to spot and locate all candidate general objects at step 1444. Target object is then recognized from the candidates based on similarity evaluation on characteristic features between the extracted feature from the candidates and the previously learned feature information about the target object at 1448. The newly extracted feature information is further learned by the ORL function 528 after a general object is confirmed as the target object. After that, the position and size of the recognized general object are rendered as the identified position and size for the target object at 1452. Digital signal filtering may be used in this rendering process. This round of processing ends at step 1456. In every panorama view image generation cycle, the method 1400 is repeated for each of the connected users to determine the identified position and size for their individually specified target object.

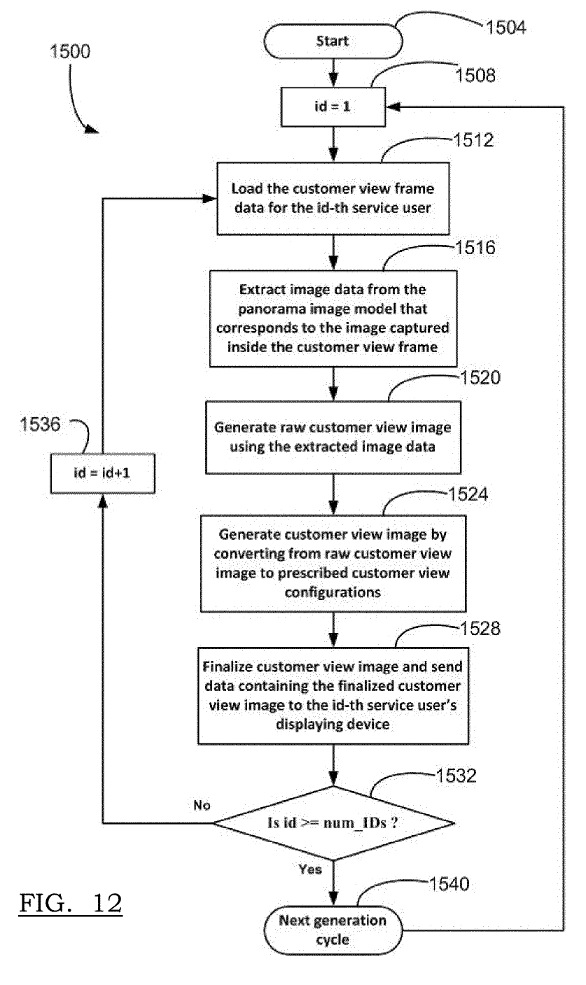

With reference to FIG. 12, a method for generating customer view image is illustrated according to one or more embodiments and is generally referenced by numeral 1500. After starting at step 1504, the method first work on customer view generation for the first connected user with id=1 at step 1508. The customer view frame data for the id-th connected user is loaded to the system memory at step 1512. The shape, position and size of the customer view frame are used to identify the image data from the data structure of the panorama view image to be extracted. At step 1516, the image data associated to pixel positions that are enclosed by the customer view frame are taken out and prepared for customer view generation in the next step 1520. In an exemplary case, for a rectangular customer view frame, the image area inside the rectangular area is directly extracted and copied to a customer view template to make a raw version of the customer view image. The conversion on the raw customer view image at step 1524 may also apply image processing including resize, resolution conversion, color format change, data format change, similarity transform, affine and projective transforms and 3D transformation. At step 1528, the customer view image is finalized with optional add-on features including watermark, caption, highlight, decoration, overlapping image and even advertisement. The finalized customer view image is next send to the id-th service user's displaying device through the communication network 38. The method 1500 next checks on if the processing steps from 1512 to 1528 have been finished for all the connected users at step 1532. If not, the id will be added by one at step 1536 and the process goes back to step 1512 to start producing customer view image for the new id-th connected service user. When it is checked that all the num_IDs numbers of connected users' customer view images have been successfully produced at step 1532, the method 1500 next go to step 1540 to start a new cycle of generation process.

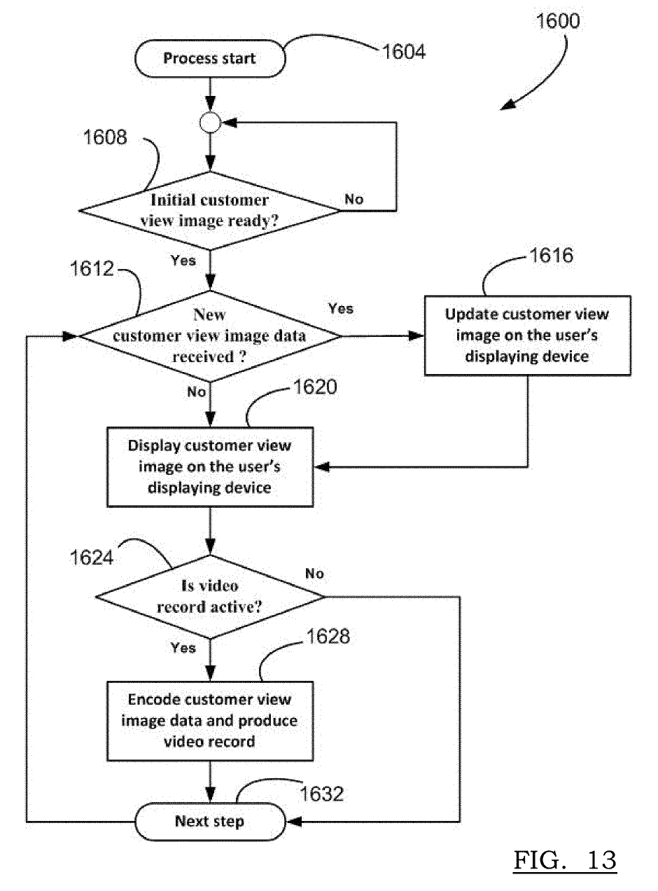

With reference to FIG. 13, a method for customer view image presentation on a user's displaying device is illustrated according to one or more embodiments and is generally referenced by numeral 1600. After starting at step 1604, the method first checks on if an initial customer view image is ready at step 1608. The initial customer view image can either be a default service image loaded from user's displaying device or a customer view image that is produced by the view presentation control center 50 based on a default or a latest updated customer view frame settings. Once the initial customer view image is ready, the view presentation service starts. At step 1612, the method 1600 checks on if new customer view image data is received from the view presentation control center 50 based on the latest updated customer view frame data. When received, the customer view image data on the memory of the user's displaying device gets updated at step 1616. The most recently updated customer view image is then displayed on the user's displaying device at step 1620. The method 1600 next decides if video recording is requested based on user's input and settings at step 1624. If requested, the customer view image data are encoded and added to a target movie file at step 1628. Otherwise, after step 1632, the process switches back to step 1612 to check on new customer view image data reception. In this manner, customer view video stream is created and is continuously displayed and/or recorded on the user's displaying device.

As demonstrated by the embodiments described above, the methods and systems of the present invention provide advantages over the prior art by integrating camera systems and displaying devices through automatic object tracking view presentation control methods and communication systems. The resulted service system is able to provide applications enabling automatic object tracking view presentation inside a commonly shared panorama view to support individually specified object following view presentation service to crowd users. The data transmission is minimized when sending only the customer view image to each of the crowd users within communication throughput limit.

While the best mode has been described in detail, those familiar with the art will recognize various alternative designs and embodiments within the scope of the following claims. Additionally, the features of various implementing embodiments may be combined to form further embodiments of the invention. While various embodiments may have been described as providing advantages or being preferred over other embodiments or prior art implementations with respect to one or more desired characteristics, those of ordinary skill in the art will recognize that one or more features or characteristics may be compromised to achieve desired system attributes, which depend on the specific application and implementation. These attributes may include, but are not limited to: cost, strength, durability, life cycle cost, marketability, appearance, packaging, size, serviceability, weight, manufacturability, ease of assembly, etc. The embodiments described herein that are described as less desirable than other embodiments or prior art implementations with respect to one or more characteristics are not outside the scope of the disclosure and may be desirable for particular applications. Additionally, the features of various implementing embodiments may be combined to form further embodiments of the invention.

What is claimed is:

1. A method for providing automatic object tracking view presentation inside a panorama view for crowd service comprising:
obtaining at least one camera view image;
generating a panorama view image using said at least one camera view image;
for each connected user, determining a customer view frame inside said panorama view image such that the image of a target object specified by said each connected user is sufficiently covered and centered inside the panorama image area defined by said customer view frame; and wherein said customer view frame is determined based on view navigation data comprising the identified position and size of said target object and the received user inputs;
extracting image data from the image area of said panorama view image inside said customer view frame;
processing said extracted image data to generate a customer view image;
transmitting said customer view image to at least one user's displaying device;
playing said customer view image on said at least one user's displaying device.

2. The method of claim 1, wherein said panorama view image is generated from a plurality of said camera view images using at least one of the following methods:
image transformation method;
image stitching method;
image combination method that is based on a predefined image transformation and stitching scheme.

3. The method of claim 1, wherein said customer view frame is a closed geometric region defined inside the image frame of said panorama view image, and wherein said customer view frame has properties including position and size.

4. The method of claim 3, wherein said position and size of said customer view frame is determined relatively to said identified position and size of said target object using at least one of the methods including: centering, center aligning, offset, expanding, shrinking, aspect ratio adjustment, rotation, and shape variations.

5. The method of claim 1, wherein said received user inputs comprise at least one of fundamental operations that include: target object selection, target object cancellation, translational motion, zoom-in motion, zoom-out motion, rotation motion and perspective angular motion.

6. The method of claim 1, wherein said customer view image is generated using at least one of image processing methods that include: resize, resolution conversion, format and color conversion, similarity transformation, perspective transformation, 3D transformation and data compression.

7. The method of claim 1, wherein said identified position and size of said target object is derived from the evaluated position and size of a general object that is being specified as said target object by said each connected user.

8. The method of claim 1, wherein said identified position and size of said target object is derived from the evaluated position and size of a general object that is recognized as said target object.

9. The method of claim 1, wherein said identified position of said target object is derived from the position measurement of a positioning device, and said identified size of said target object is derived from the size of a general object recognized as said target object at a position corresponding to said position measurement in a panorama view image that is associated to said position measurement; and wherein said panorama view image that is associated to said position measurement is also used to extract said image data for generating said customer view image.

10. The method of claim 1, wherein said identified position and size of said target object is derived from the object location data of an object tracking device to determine said customer view frame; and wherein said image data are extracted from a panorama view image that is associated to said object location data for generating said customer view image.

11. A system for providing automatic object tracking view presentation inside a panorama view for crowd service comprising:
memory, configure to store a program of instructions and data;
a communication network;
at least one camera system to capture camera view image;
at least one processor operably coupled to said memory, and said communication network, and said at least one camera system to execute said program of instructions, wherein when said program of instruction is executed, carries out the steps of:
obtaining at least one camera view image from said at least one camera system;
generating a panorama view image using said at least one camera view image;
for each connected user, determining a customer view frame inside said panorama view image such that the image of a target object specified by said each connected user is sufficiently covered and centered inside the panorama image area defined by said customer view frame; and wherein said customer view frame is determined based on view navigation data comprising the identified position and size of said target object and the received user inputs;
extracting image data in memory locations that correspond to the image area of said panorama view image inside said customer view frame;
processing said extracted image data to generate a customer view image;
transmitting said customer view image to at least one user's displaying device.

12. The system of claim 11, wherein said panorama view image is generated by combining a plurality of said camera view images using image combination methods and wherein said panorama view image is a data structure model stored on said memory.

13. The system of claim 11, wherein said customer view frame is a data structure defined for a closed geometric region inside the image frame of said panorama view image, and wherein said customer view frame has size and position properties stored on said memory.

14. The system of claim 13, wherein said position and size of said customer view frame is determined relatively to said identified position and size of said target object involving at least one of the operations including: centering, center aligning, offset, expanding, shrinking, aspect ratio adjustment, rotation, and shape variations.

15. The system of claim 11, wherein said received user inputs are received from said user's displaying device via said communication network, and wherein said received user inputs comprise instructions that result in operation on said customer view frame including at least one of: target object initialization, target object cancellation, translational operation, zoom operation, rotation operation and perspective angular operation.

16. The system of claim 11, wherein said customer view image is generated by operations on said memory that result in changes on said extracted image data including at least one of resize, resolution conversion, format and color conversion, similarity transformation, perspective transformation, 3D transformation and data compression.

17. The system of claim 11, wherein said program of instruction is executed, further carries out the steps of:
locating at least one general object inside said panorama view image;
evaluating the position and size of said at least one general object;
specifying one of said at least one general object as said target object for said each connected user;
rendering said evaluated position and size of said specified one general object as the identified position and size of said target object.

18. The system of claim 11, wherein said program of instruction is executed, further carries out the steps of:
locating at least one general object inside said panorama view image;
evaluating the position and size of said at least one general object;
recognizing one of said at least one general object as said target object for said each connected user;
rendering the evaluated position and size of said recognized one general object as the identified position and size of said target object.

19. The system of claim 11 further comprises a positioning device that generates position measurement to locate said target object for said each connected user; and wherein said program of instruction is executed, further carries out the steps of:
locating at least one general object at a position corresponding to said position measurement in a panorama view image that is associated to said position measurement, wherein said panorama view image that is associated to said position measurement is also used to extract said image data for generating said customer view image;
evaluating the size of said at least one general object;
recognizing one of said at least one general object as said target object for said each connected user;
rendering said position corresponding to said position measurement in said associated panorama view image and the evaluated size of said recognized one general object as the identified position and size of said target object.

20. The system of claim 11 further comprises an object tracking device that generates object location data to locate the position and size of said target object for said each connected user; and wherein said program of instruction is executed, further carries out the steps of:
deriving the identified position and size of said target object for said each connected user from said object location data;
identifying a panorama view image that is associated to said object location data, wherein said associated panorama view image is used to extract said image data for generating said customer view image.
